(19) United States
(12) Patent Application Publication
(10) Pub. No.: US 2026/0356210 A1
(43) Pub. Date: Nov. 12, 2026

(54) MOTOR DRIVING APPARATUS AND ELECTRIFIED VEHICLE USING THE SAME

(71) Applicants: Hyundai Motor Companay, Seoul (KR); Kia Corporation, Seoul (KR)

(72) Inventors: Tae Jun MOON, Hwaseong-si (KR); Ho Rim Choi, Hwaseong-si (KR); Jin Wook Kang, Hwaseong-si (KR); Tae Gyeom Woo, Hwaseong-si (KR); Tae II Yoo, Hwaseong-si (KR); Sang Woo Park, Hwaseong-si (KR)

(73) Assignees: Hyundai Motor Company, Seoul (KR); Kia Corporation, Seoul (KR)

(21) Appl. No.: 19/393,300

(22) Filed: Nov. 18, 2025

(30) Foreign Application Priority Data
May 12, 2025 (KR) 10-2025-0061397

(51) Int. Cl. B60L 15/20; B60L 15/02; B60L 15/08

(52) U.S. Cl. CPC B60L 15/2045; B60L 15/025; B60L 15/08; B60L 2210/42; B60L 2240/421; B60L 2240/423; B60L 2240/429; B60L 2240/526

(57) ABSTRACT

A motor driving apparatus includes a first inverter including a plurality of first switching elements and connected to a first three-phase winding of a dual three-phase motor, a second inverter including a plurality of second switching elements and connected to a second three-phase winding of the dual three-phase motor, and a controller configured to drive the dual three-phase motor in any one of a first single three-phase mode for driving the first inverter, a second single three-phase mode for driving the second inverter, or a dual three-phase mode for driving the first inverter and the second inverter together, wherein the first three-phase winding and the second three-phase winding have different inductances, and an electrified vehicle using the same.

### CROSS-REFERENCE TO RELATED APPLICATION

The present application claims the benefit of priority to Korean Patent Application No. 10-2025-0061397, filed on May. 12, 2025, the entire contents of which is herein for all purposes by this reference.

### BACKGROUND

### Field of the Present Disclosure.

The present disclosure relates to a motor driving apparatus configured for efficiently driving a motor and an electrified vehicle using the same.

### Description of Related Art

In general, one end of each of windings of respective phases included in a motor is connected to an inverter and the other ends of the windings of the respective phases are interconnected to form a Y-connection.

When the motor is driven, a switching element inside the inverter is turned on or off by pulse width modulation control, applying line voltage to the Y-connected windings of the motor to generate alternating current, thereby generating torque.

Fuel efficiency (or power efficiency) of an eco-friendly vehicle such as an electric vehicle that uses the torque generated by such a motor as power is determined by power conversion efficiency of the inverter-motor. Therefore, to improve fuel efficiency, it is important to maximize power conversion efficiency of the inverter and efficiency of the motor.

Efficiency of an inverter-motor system is mainly determined by a voltage utilization rate of the inverter. When an operating point of the vehicle is formed by a relationship between a motor speed and torque in a section having a high voltage utilization rate, fuel efficiency of the vehicle may be improved.

However, as the number of windings of the motor is increased to increase the maximum torque of the motor, the section having the high voltage utilization rate becomes farther away from a low torque region, which is a main operating point of the vehicle, so that fuel efficiency may decrease. In addition, when the main operating point is designed to be included in the section having the high voltage utilization rate from the perspective of fuel efficiency, starting performance may deteriorate due to restrictions on the maximum torque of the motor.

In addition, in the case of a system using a three-phase permanent magnet synchronous motor, which is widely used in electrified vehicles, power density and stability may be high while it is expensive to manufacture a high-output power module for driving a high-capacity motor and fault response operation may be difficult when a motor or an inverter fails during operation.

Accordingly, in the present field of the present disclosure, research has been conducted on a dual three-phase permanent magnet synchronous motor system that uses a motor including two sets of windings and two low-power power modules instead of one high-capacity motor and one high-power power module to achieve effects such as high power, high efficiency, reduced torque ripple, and reduced noise.

The matters described as background technology above are only intended to enhance understanding of the background of the present disclosure, and should not be taken as an acknowledgment that the matters correspond to the related art already known to those of ordinary skill in the art.

### BRIEF SUMMARY

Accordingly, an aspect of the disclosed exemplary embodiments is to provide a motor driving apparatus configured for efficiently driving a dual three-phase motor and a vehicle using the same.

Aspects to be achieved in the present disclosure are not limited to the aspect mentioned above, and other aspects not mentioned herein will be clearly understood by a person having ordinary skill in the field of the present disclosure to which the present disclosure pertains from the description below.

According to various aspects of the present disclosure, the above and other objects can be accomplished by the provision of a motor driving apparatus including a first inverter including a plurality of first switching elements and connected to a first three-phase winding of a dual three-phase motor, a second inverter including a plurality of second switching elements and connected to a second three-phase winding of the dual three-phase motor, and a controller operatively connected to the first inverter and the second inverter and configured to drive the dual three-phase motor in any one of a first single three-phase mode for driving the first inverter, a second single three-phase mode for driving the second inverter, or a dual three-phase mode for driving the first inverter and the second inverter together, wherein the first three-phase winding and the second three-phase winding have different inductances.

According to various aspects of the present disclosure, the controller may drive the dual three-phase motor based on a map in which a first region corresponds to the first single three-phase mode, a second region corresponds to the second single three-phase mode, and a third region corresponds to the dual three-phase mode are set according to a driving point.

According to various aspects of the present disclosure, the motor driving apparatus may further include a circulating current controller configured to reduce a circulating current caused by a difference in applied voltage between the first three-phase winding and the second three-phase winding.

According to various aspects of the present disclosure, the controller may turn off the circulating current controller based on the dual three-phase motor being driven in the first single three-phase mode and the second single three-phase mode, and may turn on the circulating current controller based on the dual three-phase motor being driven in the dual three-phase mode.

According to various aspects of the present disclosure, the map may be set by considering efficiency and output torque of the dual three-phase motor.

According to various aspects of the present disclosure, the map may include a first axis corresponding to a rotation speed of the dual three-phase motor and a second axis corresponding to a torque command of the dual three-phase motor.

According to various aspects of the present disclosure, the third region may correspond to a region in which the torque command of the dual three-phase motor is greater than the torque command in the first region and the second region, and the first region may correspond to a region in which the torque command of the dual three-phase motor is greater than the torque command in the second region.

According to various aspects of the present disclosure, the map may have first reference torque configured as a criterion for determining a driving mode and second reference torque smaller than the first reference torque, and a region corresponding to a torque command range greater than the first reference torque may correspond to the third region, a region corresponding to a torque command range smaller than the second reference torque may correspond to the second region, and other regions may correspond to the first region.

According to various aspects of the present disclosure, the map may include a plurality of sections according to a rotation speed of the dual three-phase motor, and each section may include the first reference torque and the second reference torque.

According to various aspects of the present disclosure, the controller may be configured to determine a driving mode by considering a first state determined based on a preset first reference speed, a second state determined based on a second reference speed, and a third state determined based on a first reference torque and a second reference torque.

According to various aspects of the present disclosure, the second reference speed may be determined based on the first state, and the first reference torque and the second reference torque may be determined based on the first state and the second state.

According to various aspects of the present disclosure, the first state may include a first level based on a rotation speed of the dual three-phase motor being greater than the first reference speed, and may include a 0th level otherwise.

According to various aspects of the present disclosure, the second state may include the first level based on the second reference speed being greater than the rotation speed of the dual three-phase motor, and may include the 0th level otherwise.

According to various aspects of the present disclosure, the third state may include a second level based on a torque command being greater than the first reference torque, include the 0th level based on the torque command being less than the second reference torque, and include the first level otherwise, and the second reference torque may be smaller than the first reference torque.

According to various aspects of the present disclosure, the controller may be configured to drive the dual three-phase motor in the first single three-phase mode based on all of the first state, the second state, and the third state including the 0th level, drive the dual three-phase motor in the second single three-phase mode based on the first state and the second state including the first level and the third state including the 0th level, and drive the dual three-phase motor in the dual three-phase mode based on the third state including the second level.

According to various aspects of the present disclosure, there is provided an electrified vehicle including a dual three-phase motor in which a first three-phase winding and a second three-phase winding have different inductances, a first inverter including a plurality of first switching elements and connected to the first three-phase winding of the dual three-phase motor, a second inverter including a plurality of second switching elements and connected to the second three-phase winding of the dual three-phase motor, and a controller operatively connected to the first inverter and the second inverter and configured to drive the dual three-phase motor in any one of a first single three-phase mode for driving the first inverter, a second single three-phase mode for driving the second inverter, or a dual three-phase mode for driving the first inverter and the second inverter together.

According to various aspects of the present disclosure, the controller may further include a circulating current controller configured to reduce a circulating current caused by a difference in applied voltage between the first three-phase winding and the second three-phase winding, and the controller may turn off the circulating current controller based on the dual three-phase motor being driven in the first single three-phase mode and the second single three-phase mode, and may turn on the circulating current controller based on the dual three-phase motor being driven in the dual three-phase mode.

According to various aspects of the present disclosure, the controller may drive the dual three-phase motor based on a map in which a first region corresponds to the first single three-phase mode, a second region corresponds to the second single three-phase mode, and a third region corresponds to the dual three-phase mode are set according to a driving point, and the map may be set by considering efficiency and output torque of the dual three-phase motor.

According to various aspects of the present disclosure, the map may include a first axis corresponding to a rotation speed of the dual three-phase motor and a second axis corresponding to a torque command of the dual three-phase motor, the third region may correspond to a region in which the torque command of the dual three-phase motor is greater than the torque command in the first region and the second region, and the first region may correspond to a region in which the torque command of the dual three-phase motor is greater than the torque command in the second region.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a circuit diagram illustrating an example of a motor driving apparatus including a battery, a plurality of inverters, a motor, and a controller configured for controlling the same according to an exemplary embodiment of the present disclosure;

FIG. 2 is a circuit diagram illustrating an equivalent circuit of a dual three-phase motor according to an exemplary embodiment of the present disclosure;

FIG. 3 is a block diagram illustrating an example of a process in which the controller configured to control the dual three-phase motor receives a torque command and various information related to the motor and generates a motor control signal according to an exemplary embodiment of the present disclosure;

FIG. 4 is a block diagram illustrating an example of a process in which a circulating current controller of a current control unit is configured to reduce a circulating current according to an exemplary embodiment of the present disclosure;

FIG. 5 is a block diagram illustrating an example of a process in which the current control unit of the controller is configured to generate the first voltage command and the second voltage command according to an exemplary embodiment of the present disclosure;

FIG. 6 is a block diagram illustrating an example of a process in which a voltage modulation unit of the controller is configured to receive information related to a voltage command and a driving mode and generates a control signal according to an exemplary embodiment of the present disclosure;

FIG. 7 illustrates a configuration example of a map referenced by a mode determination unit of the controller when determining a driving mode of the dual three-phase motor according to an exemplary embodiment of the present disclosure;

FIG. 8 is a flowchart illustrating an example of a process in which the mode determination unit is configured to determine a first state, a second state, and a third state and is configured to determine a driving mode based on the same according to an exemplary embodiment of the present disclosure; and

FIG. 9 is a flowchart illustrating an example of a process in which the controller is configured to control the circulating current controller according to a motor driving mode according to an exemplary embodiment of the present disclosure.

### DETAILED DESCRIPTION

Hereinafter, various exemplary embodiments disclosed in the present specification will be described in detail with reference to the appended drawings. However, identical or similar components will be assigned the same reference numbers regardless of reference symbols, and duplicate descriptions thereof will be omitted. The suffixes "module" and "unit" for components used in the following description are provided or used interchangeably only for the ease of preparing the specification, and do not have distinct meanings or roles in themselves. In addition, in describing embodiments disclosed in the present specification, when it is determined that a detailed description of related publicly known technology may obscure the gist of the exemplary embodiments disclosed in the present specification, the detailed description thereof will be omitted. In addition, the appended drawings are only for easy understanding of the exemplary embodiments disclosed in the present specification, and the technical idea disclosed in the present specification is not limited by the appended drawings. Furthermore, it should be understood that the present disclosure encompasses all changes, equivalents, and substitutes included in the spirit and technical scope of the present disclosure.

Although terms including ordinal numbers, such as "first", "second", etc., may be used herein to describe various components, the components are not limited by these terms. These terms are generally only used to distinguish one component from another.

When a component is referred to as being "coupled" or "connected" to another component, the component may be directly coupled or connected to the other component. However, it should be understood that another component may be present therebetween. In contrast, when a component is referred to as being "directly coupled" or "directly connected" to another component, it should be understood that there are no other components therebetween.

A singular expression includes the plural form unless the context clearly dictates otherwise.

In the present specification, it should be understood that a term such as "include" or "have" is intended to designate that the features, numbers, steps, operations, components, parts, or combinations thereof described in the specification are present, and does not preclude the possibility of presence or addition of one or more other features, numbers, steps, operations, components, parts, or combinations thereof.

In addition, the term "unit" or "control unit" included in a name such as a motor control unit (MCU) is merely a widely used term for naming a controller that is configured to control a specific vehicle function, and does not mean a generic functional unit. For example, each controller may include a communication device that communicates with another controller or a sensor to control a function assigned thereto, a memory that stores an operating system, a logic command, input/output information, etc., and one or more processors that perform determination, calculation, decision, etc. necessary for controlling a function assigned thereto.

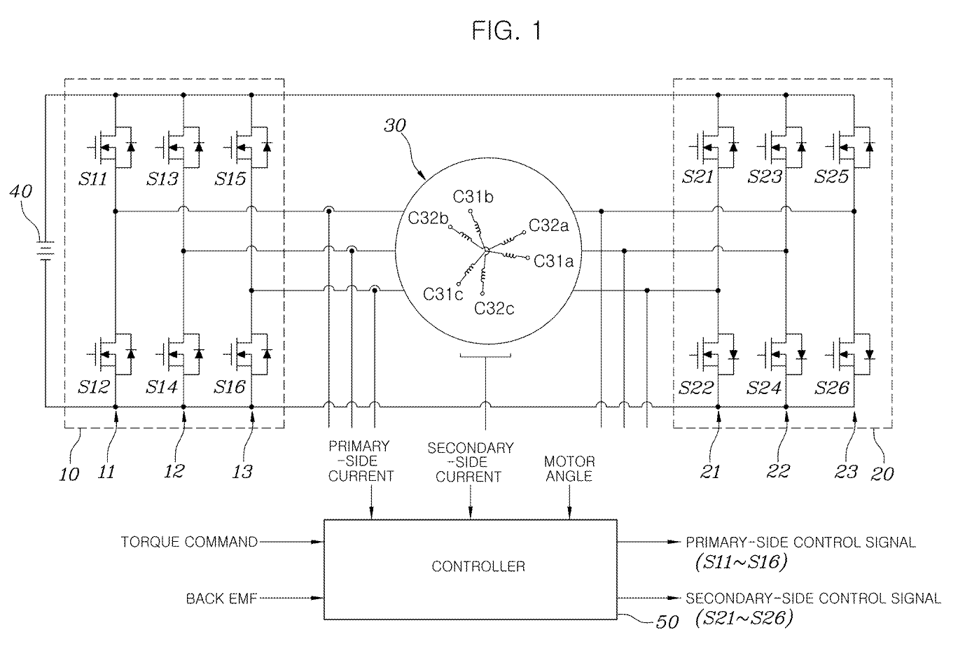

FIG. 1 is a circuit diagram illustrating an example of a motor driving apparatus including a battery, a plurality of inverters, a motor, and a controller configured for controlling the same according to an exemplary embodiment of the present disclosure.

Referring to FIG. 1, the motor driving apparatus according to the exemplary embodiment of the present disclosure may include a first inverter 10, a second inverter 20, a motor 30 including a plurality of first three-phase windings C31a, C31b, and C31c and a plurality of second three-phase windings C32a, C32b, and C32c corresponding to a plurality of phases, respectively, a battery 40, and a controller 50.

The first inverter 10 may include a plurality of first switching elements S11, S12, S13, S14, S15 and S16 connected to each of the plurality of first three-phase windings C31a, C31b, and C31c, and the second inverter 20 may include a plurality of second switching elements S21, S22, S23, S24, S25 and S26 connected to each of the plurality of second three-phase windings C32a, C32b, and C32c. The controller 50 may be configured for controlling ON/OFF states of the first switching elements S11, S12, S13, S14, S15 and S16 and the second switching elements S21, S22, S23, S24, S25 and S26 based on a motor torque command, DC terminal voltages of the first inverter 10 and the second inverter 20 (i.e., the voltage of the battery), a phase current of the motor, and a motor angle.

The first inverter 10 may include a plurality of primary-side legs 11, 12, and 13 to which a DC voltage is applied by the battery 40. The respective legs 11, 12, and 13 may correspond to a plurality of phases of the first three-phase windings C31a, C31b, and C31c, respectively, to form electric connection.

The first leg 11 among the primary-side legs includes two switching elements S11 and S12 connected in series, and a connection node of the two switching elements S11 and S12 may be connected to the winding C31a of one phase in the motor 30 so that AC power corresponding to one of the plurality of phases may be input and output. Similarly, the second leg 12 includes two switching elements S13 and S14 connected in series, and a connection node of the two switching elements S13 and S14 may be connected to the winding C31b of one phase in the motor 30 so that AC power corresponding to one of the plurality of phases may be input and output. Furthermore, the third leg 13 includes two switching elements S15 and S16 connected in series, and a connection node of the two switching elements S15 and S16 may be connected to the winding C31c of one phase of the motor 30 so that AC power corresponding to one of the plurality of phases is input and output.

The second inverter 20 may include a plurality of secondary-side legs 21, 22, and 23 to which a DC voltage is applied by the battery 40. The respective legs 21, 22, and 23 may correspond to a plurality of phases of the second three-phase windings C32a, C32b, C32c, respectively, to form electric connection.

The first leg 21 among the secondary-side legs includes two switching elements S21 and S22 connected in series, and a connection node of the two switching elements S21 and S22 may be connected to the winding C32a of one phase in the motor 30 so that AC power corresponding to one of the plurality of phases may be input and output. Similarly, the second leg 22 includes two switching elements S23 and S24 connected in series, and a connection node of the two switching elements S23 and S24 may be connected to the winding C32b of one phase in the motor 30 so that AC power corresponding to one of the plurality of phases may be input and output. In addition, the third leg 23 includes two switching elements S25 and S26 connected in series, and a connection node of the two switching elements S25 and S26 may be connected to the winding C32c of one phase of the motor 30 so that AC power corresponding to one of the plurality of phases is input and output.

Although not illustrated in FIG. 1, the motor driving apparatus may further include a so-called Y-capacitor (Y-Cap) that connects two capacitors connected in series between a positive (+) DC terminal and a negative (-) DC terminal, and grounds a connection node between the capacitors.

The controller 50 may perform a control operation so that the motor 30 may be driven by switching the switching elements S11, S12, S13, S14, S15 and S16 , and S21, S22, S23, S24, S25 and S26 included in the first inverter 10 and the second inverter 20 through pulse width modulation control based on a torque command required for the motor 30.

Furthermore, the controller 50 may be configured for controlling the ON/OFF state of the first switching elements S11, S12, S13, S14, S15 and S16 and the second switching elements S21, S22, S23, S24, S25 and S26 according to a motor driving mode. The motor driving mode may include a first single three-phase mode, a second single three-phase mode, and a dual three-phase mode.

When driving the motor 30 in the first single three-phase mode or the second single three-phase mode, the controller 50 may drive the motor 30 through only one of the two inverters 10 and 20, and when driving the motor 30 in the dual three-phase mode, the controller 50 may drive the motor 30 using both the first inverter and the second inverter.

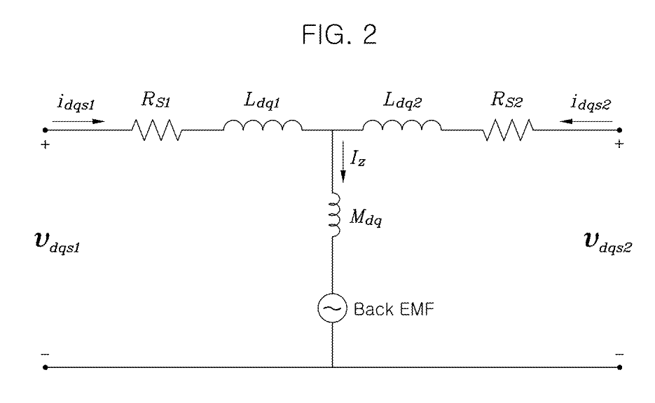

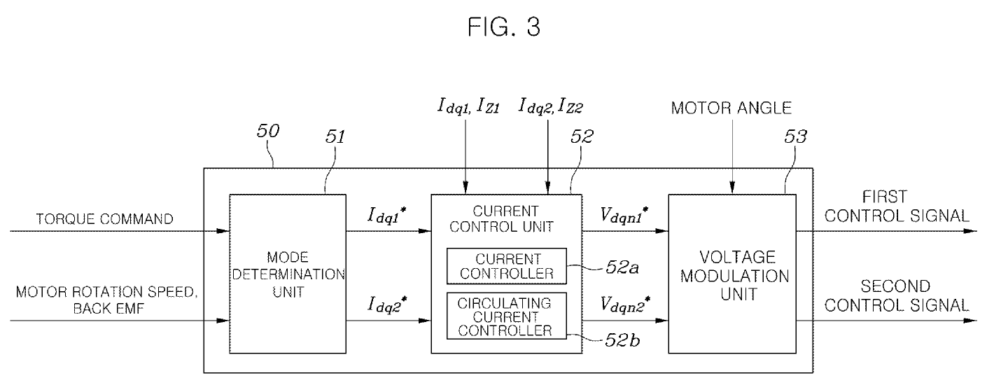

Hereinafter, structures of the motor 30 and the controller 50 will be described in more detail with reference to FIGS. 2 and 3.

FIG. 2 is a circuit diagram illustrating an equivalent circuit of a dual three-phase motor according to an exemplary embodiment of the present disclosure.

FIG. 2 illustrates an equivalent circuit expressed based on results of performing synchronous coordinate system d-q transformation for each variable of the dual three-phase motor according to the exemplary embodiment of the present disclosure. In more detail, a voltage of v_{dqs1} may be applied to the first three-phase windings of the motor 30, and a voltage of v_{dqs2} may be applied to the second three-phase windings. In addition, the motor 30 may have an internal resistance Rₛ₁ due to the first three-phase windings and an inductance L_{dq1} of the first three-phase windings, and similarly have an internal resistance Rₛ₂ due to the second three-phase windings and an inductance L_{dq2} of the second three-phase windings. Furthermore, mutual inductance M_{dq} may be present between the first three-phase windings and the second three-phase windings.

As an example of motor design, a phase difference between the first three-phase windings and the second three-phase windings of the dual three-phase motor may be determined to be 30 degrees, and the inductance L_{dq1} of the first three-phase windings and the inductance L_{dq2} of the second three-phase windings may be designed to be the same.

In the instant case, since the mutual inductance M_{dq} between the first three-phase windings and the second three-phase windings generally has a larger value than the inductance L_{dq1} of the first three-phase windings and the inductance L_{dq2} of the second three-phase windings, voltage interference between the windings is large. Furthermore, the phase difference between the first three-phase windings and the second three-phase windings may cause power loss and a control problem due to increase in a fifth harmonic current and a seventh harmonic current when the motor is driven in a high-speed region.

On the other hand, as in an example according to an exemplary embodiment of the present disclosure, the inductance L_{dq1} of the first three-phase windings and the inductance L_{dq2} of the second three-phase windings may be designed to have different values. For example, when the first three-phase windings and the second three-phase windings are configured as the same conductor, the inductance L_{dq1} of the first three-phase windings and the inductance L_{dq2} of the second three-phase windings may have different values by setting turn ratios of the respective windings to be different. An advantage of driving strategy and circulating current control by the present design will be described in detail later.

FIG. 3 is a block diagram illustrating an example of a process in which the controller configured to control the dual three-phase motor receives a torque command and various information related to the motor and generates a motor control signal according to an exemplary embodiment of the present disclosure.

Referring to FIG. 3, the controller 50 may include a mode determination unit 51, a current control unit 52, and a voltage modulation unit 53.

The mode determination unit 51 may receive a torque command and a Back EMF(Back ElectroMotive Force) value of the motor 30 and determine a driving mode in which the motor 30 will be driven. For example, the mode determination unit 51 may be configured to determine whether to adopt the first single three-phase mode, the second single three-phase mode, or the dual three-phase mode for driving depending on the rotation speed and torque command of the motor 30, and generate a first current command I_{dq1}^{*} for the first three-phase windings and a second current command I_{dq2}^{*} for the second three-phase windings.

The current control unit 52 may receive the first current command I_{dq1}^{*} and the second current command I_{dq2}^{*} from the mode determination unit 51, and generate a first voltage command V_{dqn1}^{*} and a second voltage command V_{dqn2.}^{*}

A current controller 52a in the current control unit 52 may be configured to generate voltage commands V_{dq1}^{*} and V_{dq2}^{*} that compensate for a difference between a current command and a motor current based on information about a current flowing through a winding in the motor 30.

A circulating current controller 52b in the current control unit 52 may be configured to generate voltage commands Vₙ₁ ^{*} and Vₙ₂ ^{*} to prevent a circulating current based on information about a circulating current flowing in a winding of the motor 30.

The voltage modulation unit 53 may receive information about the first voltage command, the second voltage command, and the motor angle, and output a first control signal for the first three-phase windings and a second control signal for the second three-phase windings accordingly.

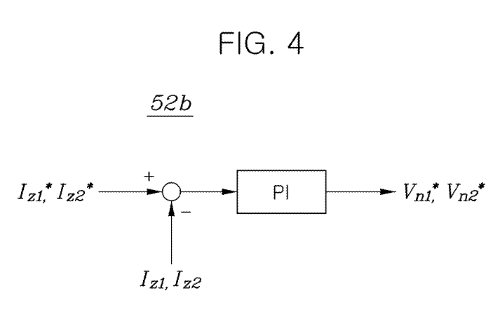

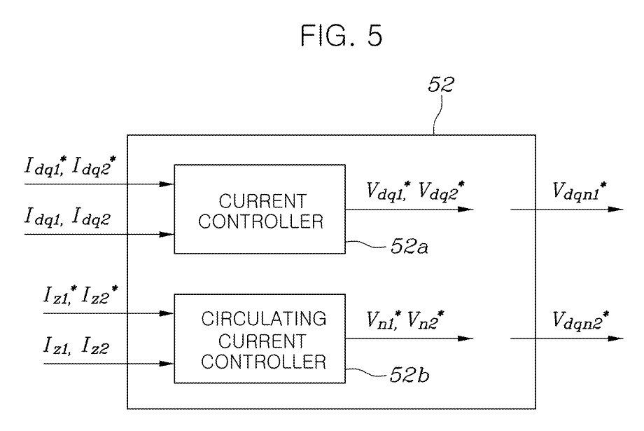

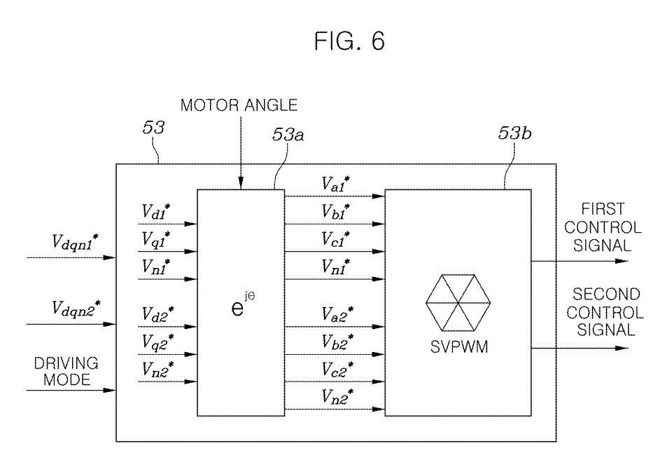

A function of the current control unit 52 will be described in detail with reference to FIGS. 4 and 5, and a function of the voltage modulation unit 53 will be described in detail with reference to FIG. 6.

FIG. 4 is a block diagram illustrating an example of a process in which the circulating current controller of the current control unit is configured to reduce a circulating current according to an exemplary embodiment of the present disclosure.

As in an example of the present disclosure, when the turn ratio of the first three-phase windings is different from the turn ratio of the second three-phase windings, the internal resistance Rₛ₁ by the first three-phase windings and the inductance L_{dq1} of the first three-phase windings may have different values from the internal resistance Rₛ₂ by the second three-phase windings and the inductance L_{dq2} of the second three-phase windings, respectively. As a result, a voltage v_{dqs1} applied to the first three-phase windings may have a different value from a voltage v_{dqs2} applied to the second three-phase windings, and thus a circulating current I_{z} may be generated in the motor, which may reduce motor efficiency.

To prevent a decrease in motor efficiency due to the circulating current I_{z}, the current control unit 52 may include the circulating current controller 52b. The circulating current controller 52b may be configured to generate voltage commands Vₙ₁ ^{*} and Vₙ₂ ^{*} to prevent circulating current through feedback control based on circulating current commands I_{z1} ^{*} and I_{z2} ^{*} and circulating currents I_{z1} and I_{z2} flowing in the respective windings. Since there is ideally no circulating current, the circulating current commands I_{z1} ^{*} and I_{z2} ^{*} may be 0.

Even though FIG. 4 illustrates a case of feedback control through a PI controller (Proportional-Integral controller), this is only an example, and it is obvious to those skilled in the art that other control methods may be used as appropriate.

FIG. 5 is a block diagram illustrating an example of a process in which the current control unit of the controller is configured to generate the first voltage command and the second voltage command according to an exemplary embodiment of the present disclosure.

Referring to FIG. 5, the current controller 52a may be configured to generate voltage commands V_{dq1}^{*} and V_{dq2}^{*} to compensate for a difference between the first current and the second current, and the first current command and the second current command based on the first current command and the second current command I_{dq1}^{*} and I_{dq2}^{*}, and a first current flowing in the first three-phase windings and a second current flowing in the second three-phase windings I_{dq1} and I_{dq2}. Furthermore, the current control unit 52 may be configured to generate the first voltage command V_{dqn1} ^{*}and the second voltage command V_{dqn2}^{*}based on the voltage commands V_{dq1} ^{*}_{,} V_{dq2}^{*}_{,} Vₙ₁^{*}_{,} and Vₙ₂^{*} generated by the current controller 52a and the circulating current controller 52b.

Although not illustrated in FIG. 5, the current control unit 52 may further include a process of generating a voltage command to offset a specific harmonic voltage based on a current command and a motor angular speed.

FIG. 6 is a block diagram illustrating an example of a process in which the voltage modulation unit of the controller is configured to receive information related to a voltage command and a driving mode and generates a control signal according to an exemplary embodiment of the present disclosure.

Referring to FIG. 6, first, a coordinate transformation unit 53a may transform a first voltage command V_{dqn1} ^{*} and a second voltage command V_{dqn2} ^{*} expressed on a d-q coordinate system into first phase voltage commands Vₐ₁ ^{*}, V_{b1} ^{*}, V_{c1} ^{*}, and Vₙ₁ ^{*} and second phase voltage commands Vₐ₂ ^{*}, V_{b2} ^{*}, V_{c2} ^{*}, and Vₙ₂ ^{*} expressed on an abc coordinate system based on information about the first voltage command V_{dqn1} ^{*}, the second voltage command V_{dqn2} ^{*}, the driving mode, and the motor angle. Furthermore, a pulse width modulation unit 53b may be configured to generate a first control signal and a second control signal using a space vector pulse width modulation (SVPWM) method based on the first phase voltage commands and the second phase voltage commands.

Although not illustrated in FIG. 6, dead time compensation (DTC) may be additionally performed in the present process to compensate for a voltage error due to a dead time to prevent short-circuiting of a switching element.

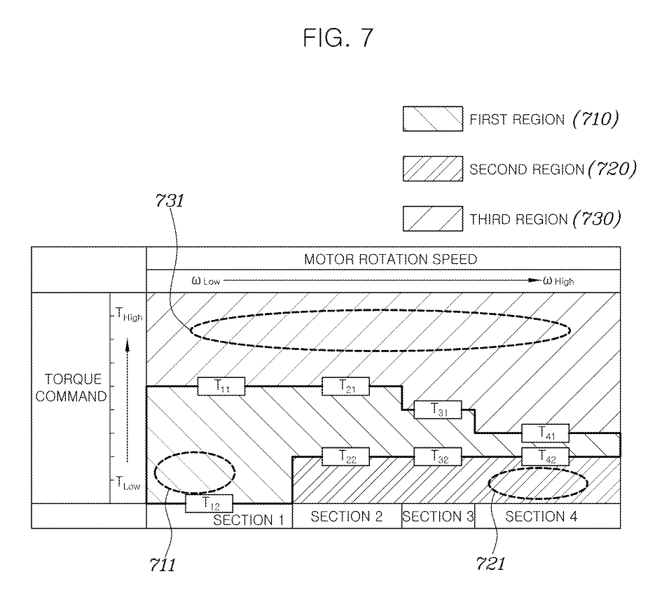

A process in which the controller 50 is configured to determine the motor driving mode and generates the control signal according to the determined driving mode has been examined. Hereinafter, a driving strategy of the dual three-phase motor system according to an exemplary embodiment will be described with reference to FIGS. 7-9.

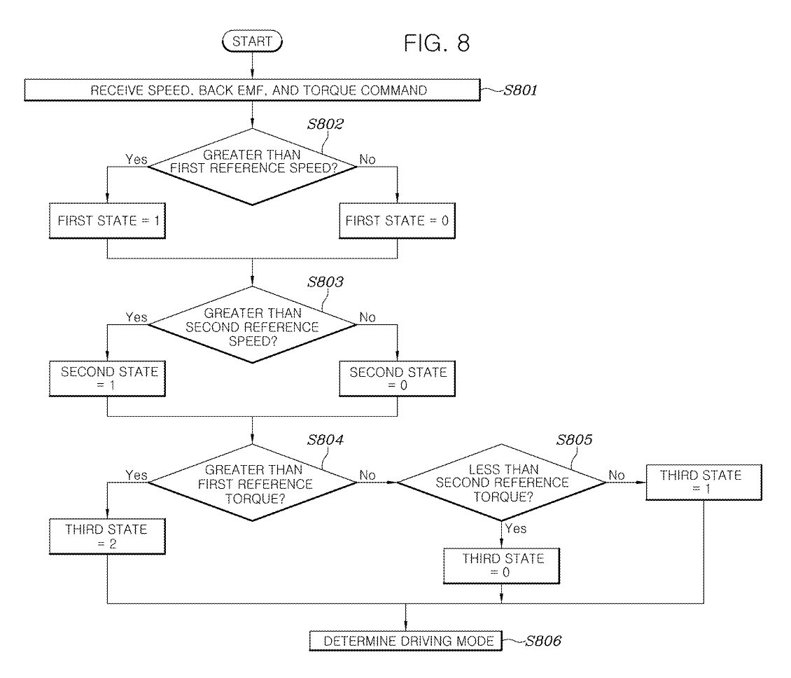

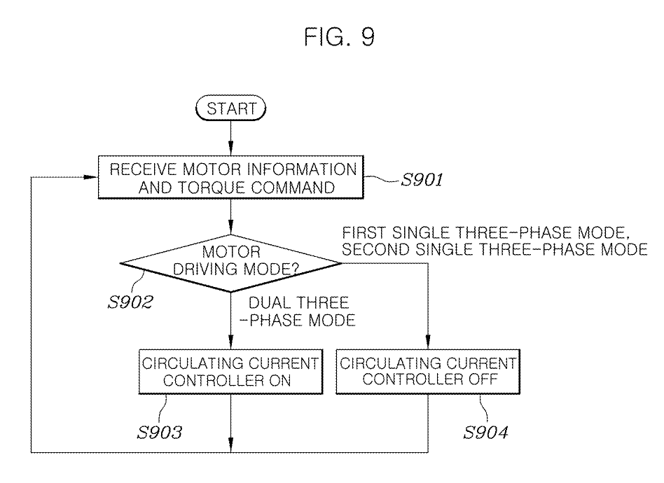

First, an example of a process in which the mode determination unit 51 is configured to determine a driving mode based on a map will be described with reference to FIG. 7, and as an exemplary embodiment of the present disclosure, an example of a process in which the mode determination unit 51 is configured to determine a driving mode based on first state information to third state information will be described with reference to FIG. 8. Furthermore, control of the circulating current controller 52b according to the driving mode will be described with reference to FIG. 9.

FIG. 7 illustrates a configuration example of a map referenced by the mode determination unit of the controller when determining a driving mode of the dual three-phase motor according to an exemplary embodiment of the present disclosure.

In FIG. 7, the inductance L_{dq1} of the first three-phase windings of the motor and the inductance L_{dq2} of the second three-phase windings of the motor are designed to have different values, and it is assumed that the inductance L_{dq1} of the first three-phase windings includes a larger value than the inductance L_{dq2} of the second three-phase windings.

Referring to FIG. 7, a map (referred to hereinafter as a "mode map" for convenience) in which regions corresponding to the first single three-phase mode, the second single three-phase mode, and the dual three-phase mode, respectively, are divided is illustrated in a region defined by a first axis corresponding to the rotation speed of the motor 30 and a second axis corresponding to the torque command.

The mode map may include a first region 710 corresponding to the first single three-phase mode, a second region 720 corresponding to the second single three-phase mode, and a third region 730 corresponding to the dual three-phase mode.

First, the first region 710 may include a region 711 in which both the rotation speed and the torque command of the motor 30 are small. In the region 711, a magnitude of current flowing to the motor is small and switching loss may be large compared to copper loss of the motor. Therefore, the mode determination unit 51 may be configured to determine to drive the motor 30 in the single three-phase mode that utilizes fewer switching elements (S11, S12, S13, S14, S15 and S16 , and S21, S22, S23, S24, S25 and S26). In the present instance, the mode determination unit 51 may achieve higher efficiency when driving the motor 30 in the first single three-phase mode having large inductance (L_{dq1} > L_{dq2}) than when driving the motor 30 in the second three-phase mode. In the present way, when driven in the single three-phase mode, a problem of circulating current does not occur, and thus the circulating current controller 52b may be controlled in the OFF state.

Meanwhile, the second region 720 may include a region 721 in which the rotation speed of the motor 30 is high and the torque command is small, and when driving is performed in the dual three-phase mode within the region, as the rotation speed of the motor 30 increases, the fifth harmonic and seventh harmonic currents may increase, which may decrease motor efficiency. In the instant case, the mode determination unit 51 drives the motor 30 in the single three-phase mode, and may exhibit higher efficiency when driving the motor 30 in the second single three-phase mode in which inductance is small (L_{dq2} < L_{dq1}) than when driving the motor 30 in the first single three-phase mode. Even in the instant case, the problem of circulating current does not occur, and thus the circulating current controller 52b may be controlled in the OFF state.

However, the third region 730 may include a region 731 in which the torque command is large, and in the region 731, the mode determination unit 51 may drive the motor 30 using all the two inverters 10 and 20 to output high torque. In the present instance, the circulating current controller 52b may be controlled in the ON state to reduce the circulating current due to a voltage difference between the two windings.

As an example of a method of determining a region corresponding to each driving mode, a plurality of reference torques (T₁₁, T₁₂, T₂₁, T₂₂, T₃₁, T₃₂, T₄₁, and T₄₂ in FIG. 7) may be set for each certain speed section (section 1 to section 4 in FIG. 7) to determine a region corresponding to each driving mode. Since motor efficiency for each driving mode may vary depending on the rotation speed of the dual three-phase motor, values of first reference torques T₁₁, T₂₁, T₃₁, and T₄₁ and second reference torques T₁₂, T₂₂, T₃₂, and T₄₂ may be different for each speed section. In the present instance, the second reference torques may be set to be smaller than the first reference torques for each section. A region corresponding to each driving mode may be determined based on the plurality of reference torques as boundaries.

However, this is only an example, and as an exemplary embodiment of the present disclosure, the mode determination unit 51 may be configured to determine a driving mode based on a map including a region defined by a first axis corresponding to a Back EMF value of the motor 30 and a second axis corresponding to a torque command.

An example of the process in which the mode determination unit 51 is configured to determine the driving mode based on the map has been described. Hereinafter, another example of driving mode determination will be described with reference to FIG. 8.

FIG. 8 is a flowchart illustrating an example of a process in which the mode determination unit is configured to determine a first state, a second state, and a third state and is configured to determine a driving mode based on the same according to an exemplary embodiment of the present disclosure.

Referring to FIG. 8, the mode determination unit 15 may be configured to determine each of levels of the first state, the second state, and the third state based on a first reference speed, a second reference speed, the first reference torques, and the second reference torques.

First, the mode determination unit 51 may receive a rotation speed, a Back EMF value, and a torque command of the motor 30 (S801), and compare the rotation speed of the motor 30 with the first reference speed to determine the first state (S802). For example, the first reference speed may be a reference speed that determines whether the motor is within an MTPA (Maximum Torque Per Ampere) control section or a field weakening control section. When the rotation speed of the motor 30 is greater than the first reference speed (Yes of S802), the first state is determined to be the first level, and in other cases (No of S802), the first state may be determined to be a 0th level.

Similarly, the mode determination unit 51 may compare the rotation speed of the motor 30 with the second reference speed to determine the second state (S803), and the second reference speed may be determined according to the first state. For example, when the motor 30 is within the MTPA control section, the reference speed according to the MTPA control section may be the second reference speed, and when the motor 30 is within the field weakening control section, the reference speed according to the field weakening control section may be the second reference speed. When the rotation speed of the motor 30 is greater than the second reference speed (Yes of S803), the second state is determined to be the first level, and in other cases, the second state may be determined to be the 0th level (No of S803).

Furthermore, the mode determination unit 51 may be configured to determine the third state by comparing the torque command of the motor 30 with each of the first reference torque and the second reference torque (S804 and S805), and the first reference torque and the second reference torque may be determined according to the first state and the second state. For example, a speed section to which the rotation speed of the motor 30 belongs may be determined according to the first reference speed and the second reference speed, and the third state may be determined by comparing each of the first reference torque and the second reference torque corresponding to the corresponding speed section with the torque command of the motor 30. When the torque command is greater than the first reference torque (Yes of S804), the third state may be determined to be the first level. When the torque command is less than the first reference torque (No of S804) and greater than the second reference torque (No of S805), the third state may be determined to be the first level. When the torque command is less than the first reference torque and the second reference torque (Yes of S805), the third state may be determined to be the 0th level.

Thereafter, the mode determination unit 51 may be configured to determine the motor driving mode based on the determined first state, second state, and third state.

As an example of determining the driving mode according to the determined first to third states, when the first state, the second state, and the third state all include a state of the 0th level, this means that the rotation speed and the torque command of the motor 30 are both small, so that the motor 30 may be driven in the first single three-phase mode. Furthermore, when the first state and the second state include a state of the first level, and the third state includes a state of the 0th level, this means that the rotation speed of the motor 30 is large but the torque command is small, so that the motor 30 may be driven in the second single three-phase mode. On the other hand, when the third state includes a state of the second level, this means a state in which the torque command is large, so that the motor 30 may be driven in the dual three-phase mode.

Meanwhile, the driving mode may be determined based on various variables other than the rotation speed and the torque command of the motor 30. For example, the driving mode may be determined based on the torque command and a difference between a reference rotation speed for distinguishing the MTPA control region and the field weakening control region and a current rotation speed of the motor 30.

FIG. 9 is a flowchart illustrating an example of a process in which the controller is configured to control the circulating current controller according to a motor driving mode according to an exemplary embodiment of the present disclosure.

When the controller 50 determines to drive the motor 30 in the dual three-phase mode based on received motor information and torque command(S901), the controller 50 may be configured for controlling the circulating current controller 52b in the ON state (S902 and S903). However, when the controller 50 determines to drive the motor 30 in the single three-phase mode, the controller 50 may be configured for controlling the circulating current controller 52b in the OFF state (S902 and S904).

The dual three-phase motor driving apparatus may be applied to various field of the present disclosures that require both a driving mode requiring high output and a driving mode requiring high efficiency, such as not only electrified vehicles such as electric vehicles and hybrid vehicles, but also aircraft electric propulsion systems or industrial high-output motors.

According to at least an exemplary embodiment of the present disclosure, for the dual three-phase motor in which the inductance of the first three-phase windings and the inductance of the second three-phase windings are different, the motor may be driven in the dual three-phase mode, the first single three-phase mode, or the second single three-phase mode depending on the driving situation, so that high output control and high efficiency control of the motor may be possible. Furthermore, by providing the circulating current controller, circulating current caused by the voltage difference between the two three-phase windings may be reduced.

Effects that may be obtained from the present disclosure are not limited to the above-mentioned effects, and other effects not mentioned herein will be clearly understood by a person having ordinary skill in the art to which the present disclosure pertains from the above description.

Even though the present disclosure has been illustrated and described above with respect to specific embodiments thereof, it will be apparent to those skilled in the art that the present disclosure may be variously improved and modified without departing from the technical spirit of the present disclosure as defined by the following claims.

What is claimed is:

1. A motor driving apparatus comprising:
a first inverter comprising a plurality of first switching elements and connected to a first three-phase winding of a dual three-phase motor;
a second inverter comprising a plurality of second switching elements and connected to a second three-phase winding of the dual three-phase motor; and
a controller operatively connected to the first inverter and the second inverter and driving the dual three-phase motor in any one of a first single three-phase mode for driving the first inverter, a second single three-phase mode for driving the second inverter, or a dual three-phase mode for driving the first inverter and the second inverter together,
wherein the first three-phase winding and the second three-phase winding have different inductances.

2. The motor driving apparatus of claim 1, wherein the controller drives the dual three-phase motor based on a driving point and a map in which a first region corresponds to the first single three-phase mode, a second region corresponds to the second single three-phase mode, and a third region corresponds to the dual three-phase mode.

3. The motor driving apparatus of claim 1, wherein the controller includes a circulating current controller reducing a circulating current caused by a difference in applied voltage between the first three-phase winding and the second three-phase winding.

4. The motor driving apparatus of claim 3, wherein the controller:
turns off the circulating current controller based on the dual three-phase motor being driven in the first single three-phase mode and the second single three-phase mode, and
turns on the circulating current controller based on the dual three-phase motor being driven in the dual three-phase mode.

5. The motor driving apparatus of claim 2, wherein the map is preset based on efficiency and output torque of the dual three-phase motor.

6. The motor driving apparatus of claim 5, wherein the map includes a first axis corresponding to a rotation speed of the dual three-phase motor and a second axis corresponding to a torque command of the dual three-phase motor.

7. The motor driving apparatus of claim 6,
wherein the third region corresponds to a region in which the torque command of the dual three-phase motor is greater than the torque command in the first region and the second region, and
wherein the first region corresponds to a region in which the torque command of the dual three-phase motor is greater than the torque command in the second region.

8. The motor driving apparatus of claim 6,
wherein the map defines a first reference torque and a second reference torque smaller than the first reference torque, and
wherein a region corresponding to a torque command range greater than the first reference torque in the map corresponds to the third region, a region corresponding to a torque command range smaller than the second reference torque in the map corresponds to the second region, and other regions in the map correspond to the first region.

9. The motor driving apparatus of claim 8, wherein the map includes a plurality of sections according to a rotation speed of the dual three-phase motor, and each section includes the first reference torque and the second reference torque.

10. The motor driving apparatus of claim 1, wherein the controller determines a driving mode based on a first state determined based on a preset first reference speed, a second state determined based on a second reference speed, and a third state determined based on a first reference torque and a second reference torque.

11. The motor driving apparatus of claim 10,
wherein the second reference speed is determined based on the first state, and
wherein the first reference torque and the second reference torque are determined based on the first state and the second state.

12. The motor driving apparatus of claim 10, wherein the first state includes a first level based on a rotation speed of the dual three-phase motor being greater than the first reference speed, and includes a 0th level otherwise.

13. The motor driving apparatus of claim 12, wherein the second state includes the first level based on the second reference speed being greater than the rotation speed of the dual three-phase motor, and includes the 0th level otherwise.

14. The motor driving apparatus of claim 13,
wherein the third state includes a second level based on a torque command being greater than the first reference torque, includes the 0th level based on the torque command being less than the second reference torque, and includes the first level otherwise, and
wherein the second reference torque is smaller than the first reference torque.

15. The motor driving apparatus of claim 14, wherein the controller:
drives the dual three-phase motor in the first single three-phase mode based on all of the first state, the second state, and the third state having the 0th level,
drives the dual three-phase motor in the second single three-phase mode based on the first state and the second state having the first level and the third state having the 0th level, and
drives the dual three-phase motor in the dual three-phase mode based on the third state having the second level.

16. An electrified vehicle comprising:
a dual three-phase motor in which a first three-phase winding and a second three-phase winding have different inductances;
a first inverter comprising a plurality of first switching elements and connected to the first three-phase winding of the dual three-phase motor;
a second inverter comprising a plurality of second switching elements and connected to the second three-phase winding of the dual three-phase motor; and
a controller operatively connected to the first inverter and the second inverter and driving the dual three-phase motor in any one of a first single three-phase mode for driving the first inverter, a second single three-phase mode for driving the second inverter, or a dual three-phase mode for driving the first inverter and the second inverter together.

17. The electrified vehicle of claim 16,
wherein the controller comprises a circulating current controller reducing a circulating current caused by a difference in applied voltage between the first three-phase winding and the second three-phase winding, and
wherein the controller turns off the circulating current controller based on the dual three-phase motor being driven in the first single three-phase mode and the second single three-phase mode, and turns on the circulating current controller based on the dual three-phase motor being driven in the dual three-phase mode.

18. The electrified vehicle of claim 16,
wherein the controller drives the dual three-phase motor based on a driving point and a map in which a first region corresponds to the first single three-phase mode, a second region corresponds to the second single three-phase mode, and a third region corresponds to the dual three-phase mode, and
wherein the map is preset based on efficiency and output torque of the dual three-phase motor.

19. The electrified vehicle of claim 18,
wherein the map includes a first axis corresponding to a rotation speed of the dual three-phase motor and a second axis corresponding to a torque command of the dual three-phase motor,
wherein the third region corresponds to a region in which the torque command of the dual three-phase motor is greater than the torque command in the first region and the second region, and
wherein the first region corresponds to a region in which the torque command of the dual three-phase motor is greater than the torque command in the second region.

20. The electrified vehicle of claim 16, wherein the controller determines a driving mode based on a first state determined based on a preset first reference speed, a second state determined based on a second reference speed, and a third state determined based on a first reference torque and a second reference torque.
